(19) United States
(12) Patent Application Publication
(10) Pub. No.: US 2008/0231575 A1
(43) Pub. Date: Sep. 25, 2008

(54) Liquid crystal panel and method for driving same

(75) Inventor: Sha Feng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/077,479

(22) Filed: Mar. 19, 2008

(30) Foreign Application Priority Data
Mar. 19, 2007 (TW) 96109267

(51) Int. Cl. G09G 3/36

(52) U.S. Cl. 345/89

(57) ABSTRACT

An exemplary liquid crystal panel (20) includes a plurality of scanning lines (23) that are parallel to each other, a plurality of data lines (24) that are parallel to each other and orthogonal to the scanning lines, at least one first data driving (221) circuit configured for proving a plurality of gray scale voltages to part of immediately adjacent data lines, and at least one second data driving circuit (222) configured for providing a plurality of gray scale voltages to the other part of the data lines. The scanning lines and date lines cooperatively define a plurality of sub-pixels (26) formed in a matrix. The polarities of the sub-pixels in each row that receive the first gray scale voltages being correspondingly opposite to the polarities of the sub-pixels in the same row that receive the second gray scale voltages.

### FIELD OF THE INVENTION

The present invention relates to liquid crystal panels and a method for driving liquid crystal panels, more particularly to a method for driving a liquid crystal panel employing a 2-line inversion driving method that can reduce a color shift phenomenon.

### GENERAL BACKGROUND

A liquid crystal display (LCD) has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions. An LCD usually includes a liquid crystal panel configured for color image display.

Referring to FIG. 3 and FIG. 4, a typical liquid crystal panel 10 includes a first substrate (not shown), a second substrate parallel to the first substrate, a liquid crystal layer (not shown) sandwiched between the first and second substrates, a gate driving circuit 11 and a data driving circuit 12.

The first substrate includes a plurality of scanning lines 13 parallel to each other, a plurality of data lines 14 parallel to each other and orthogonal to the scanning lines 13, a plurality of pixel electrodes 151, and a plurality of thin film transistors (TFTs) 15 arranged at vicinity of points of intersection of the scanning lines 13 and the data lines 14. The second substrate includes a plurality of common electrodes 152 corresponding to the pixel electrodes 151 respectively. The gate driving circuit 11 is configured for providing a plurality of scanning signals to the scanning lines 13. The data driving circuit 12 is configured for providing a plurality of gray scale voltages to the data lines 14.

Each thin film transistor 15 includes a gate electrode (not labeled) connected to a corresponding scanning line 13, a source electrode (not labeled) connected to a corresponding data line 14, and a drain electrode (not labeled) connected to a corresponding pixel electrode 151.

In the following description, unless the context indicates otherwise, a reference to a “sub-pixel” is a reference to a sub-pixel region. The gate lines 13 and the data lines 14 cooperatively define a plurality of sub-pixels 16. The sub-pixels 16 include red sub-pixels (R), green sub-pixels (G), blue sub-pixels (B). In each row, the sub-pixels 16 are arranged in a pattern of repeating “RGB”. In each column, the sub-pixels 16 have a same color. In each row, a green sub-pixel 16, an adjacent red sub-pixel 16, and an adjacent blue sub-pixel 16 cooperatively constitute a pixel region. In the following description, unless the context indicates otherwise, a reference to a “pixel” is a reference to a pixel region.

In general, a liquid crystal panel generally employs a selected one of a frame inversion system, a line inversion system, and a dot inversion system to drive the liquid crystal molecules. Each of these driving systems can protect the liquid crystal molecules from decay or being damaged.

A typical method relating to the dot inversion system is so-called a 2-line inversion driving method. FIG. 4 schematically illustrates a series of polarity patterns of part of a liquid crystal panel using a typical 2-line inversion driving method. In order to simplify the following explanation, only 4×6 pixels forming a matrix are shown. Other pixels of the liquid crystal display have a polarity arrangement similar to the illustrated matrix. As shown in FIG. 4, a polarity of each sub-pixel 16 in a first row is the same as a polarity of an adjacent sub-pixel 16 in a second row. A polarity of each sub-pixel 16 in a third row is the same as a polarity of an adjacent sub-pixel 16 in a fourth row, and is opposite to the polarity of the adjacent sub-pixel 16 in the second row. A polarity of each sub-pixel 16 in a fifth row is the same as a polarity of an adjacent sub-pixel 16 in a sixth row, and is opposite to the polarity of the adjacent sub-pixel 16 in the fourth row. The polarity of each sub-pixel 16 is opposite to the polarity of the adjacent sub-pixels 16 in the same row. Moreover, the polarity of each sub-pixel 16 is reversed once in every frame period.

By adopting the 2-line inversion driving method, the polarity of each sub-pixel 16 in a second frame is opposite to the polarity of the sub-pixel 16 in the first frame and the polarity of the sub-pixel of the third frame. Thereby, liquid crystal molecules in the liquid crystal panel are protected from decay or being damaged.

Besides, some of the pixels having light rays passing through thereof, the other pixels have no light rays passing through thereof. For each row and for each column, the pixels having light rays passing through and the pixels having no light rays passing through are alternately arranged. Each pixel having light rays passing through during a previous frame has no light rays passing through during the current frame, and vice versa.

When a scanning signal is applied to the gate electrode of each thin film transistor 15 via the corresponding scanning line 13, the thin film transistor 15 is activated. A gray scale voltage is applied to the corresponding pixel electrode 151 via the corresponding source electrode and drain electrode. The corresponding common electrode 152 is applied with a common voltage. Therefore, an electrical field is generated between the pixel electrode 151 and the common electrode 152. The liquid crystal molecules in the electrical field are twisted such that light rays are allowed to pass through. When the gray scale voltage is greater than the common voltage, the direction of the electrical field is from the pixel electrode 151 to the common electrode 152, and the sub-pixel 16 has a positive polarity. Conversely, when the gray scale voltage is less than the common voltage, the direction of the electrical field is from the common electrode 152 to the pixel electrode 151, and the sub-pixel 16 has a negative polarity. Moreover, when absolute values of the gray scale voltages applied to the pixel electrodes 151 of two sub-pixels 16 are the same, and the gray scale voltages only differ in polarity, the gray scales of the two sub-pixels 16 are assumed to be the same. The liquid crystal panel 10 is a normal white mode panel. That is, the greater the gray scale voltage applied, the less the amount of light rays that can pass through the corresponding sub-pixel 16. When the gray scale voltage is great enough, the light rays cannot pass through the corresponding sub-pixel 16.

However, there is a problem of the liquid crystal panel 10. Referring to FIG. 4 again, taking the first row of the sub-pixels 16 as an example, an amount of the sub-pixels 16 having positive polarities and light rays passing through is greater than an amount the sub-pixels 16 having negative polarities and light rays passing through in the first frame, and the amount of the sub-pixels 16 having positive polarities and light rays passing through is less than the amount of the sub-pixels 16 having negative polarities and light rays passing through in the second frame. Because the gray scale voltages correspond to the sub-pixels 16 are contrary in phase from the first frame to the second frame, the voltages of the common electrodes 152 corresponding to the pixel electrodes 151 of the sub-pixels 16 are influenced to drop down or jump up in accordance with respective directionalities of the gray scale voltages. Furthermore, the sub-pixels 16 having positive polarities in the first frame and having negative polarities in the second frame correspond to the common electrodes 152 having voltages dropping down, and the sub-pixels 16 having negative polarities in the first frame and having positive polarities in the second frame correspond to the common electrodes 152 having voltages jumping up.

Thus, an actual common voltage of the sub-pixels 16 in the first row is slightly less than an ideal common voltage of the sub-pixels 16 in the first row, The dropping of the common voltages of the common electrodes 152 that correspond the sub-pixels 16 having positive polarities in the first frame is more than the jumping of the voltages of the common electrodes 152 that correspond the sub-pixels 16 having negative polarities in the first frame.

In this situation, the red sub-pixels 16 and blue sub-pixels 16 having light rays passing there through during the second frame are applied with the actual common voltage which is greater than the ideal common voltage, and the green sub-pixels 16 having light rays passing through during the second frame are applied with the actual common voltage which is less than the ideal common voltage, so that the sub-pixels 16 in the first row display an image that is prone to be greenish, or green color shift.

Accordingly, not only the sub-pixels 16 in the first row, but also the other sub-pixels 16 display an image having color shift.

What are needed, therefore, are a liquid crystal panel and a method for driving the liquid crystal panel that can overcome the above-described deficiencies.

### SUMMARY

An exemplary liquid crystal panel includes a plurality of scanning lines that are parallel to each other, a plurality of data lines that are parallel to each other and intersect with the scanning lines, at least one first data driving circuit configured for proving a plurality of gray scale voltages to part of immediately adjacent data lines, and at least one second data driving circuit configured for providing a plurality of gray scale voltages to the other part of the data lines. The scanning lines and date lines cooperatively define a plurality of sub-pixels formed in a matrix. The polarities of the sub-pixels in each row that receive the first gray scale voltages being correspondingly opposite to the polarities of the sub-pixels in the same row that receive the second gray scale voltages.

Other novel features and advantages will become more apparent from the following detailed description when taken in conjunction with the accompanying drawings.

### BRIEF DESCRIPTION OF THE DRAWINGS

FIG. 1 is essentially an abbreviated circuit diagram of a liquid crystal panel according to an exemplary embodiment of the present invention.

FIG. 2 is an abbreviate, schematic diagram illustrating an exemplary method for driving the liquid crystal panel of FIG. 1.

FIG. 3 is essentially an abbreviated circuit diagram of a conventional liquid crystal panel.

FIG. 4 is an abbreviated, schematic diagram illustrating a conventional method for driving the conventional liquid crystal panel of FIG. 3.

### DETAILED DESCRIPTION OF PREFERRED EMBODIMENTS

Reference will now be made to the drawings to describe preferred and exemplary embodiments of the present invention in detail.

Referring to FIG. 1, this is a circuit diagram of a liquid crystal panel 20 according to an exemplary embodiment of the present invention. The liquid crystal panel 20 includes a first substrate (not shown), a second substrate (not shown) parallel to the first substrate, a liquid crystal layer (not labeled) sandwiched between the first and second substrate, a gate driving circuit 21, a plurality of first data driving circuit 221, and a plurality of second data driving circuit 222.

The first substrate includes a plurality of scanning lines 23 parallel to each other, a plurality of data lines 24 parallel to each other and orthogonal to the scanning lines 23, a plurality of pixel electrodes 251, and a plurality of TFTs 25 arranged at vicinity of points of intersection of the scanning lines 23 and the data lines 24.

The first and second data driving circuits 221, 222 are connected to data lines 24 with equal amount, respectively. The first and second data driving circuits 221, 222 are arranged in an alternate pattern. That is, every two adjacent first data driving circuits 221 are spaced by a second data driving circuit 222 and every two adjacent second data driving circuits 222 are spaced by a first data driving circuit 221. The gate driving circuit 21 is configured for providing a plurality of scanning signals to the scanning lines 23. The data lines 24 are divided into a plurality of first groups of immediately adjacent data lines 24, and a plurality of second groups of immediately adjacent data lines 24. The first groups of the data lines 24 and the second groups of the data lines 24 are alternately disposed. The first data driving circuits 221 are configured for providing a plurality of first gray scale voltages to the first groups of data lines 24 respectively, and the second data driving circuits 222 are configured for providing a plurality of second gray scale voltages to the second groups of data lines 24 respectively.

The scanning lines 23 and the data lines 24 cooperatively define a plurality of sub-pixels 26 (shown in dashed line). Each sub-pixel 26 includes red sub-pixels (R), green sub-pixels (G), and blue sub-pixels (G). The sub-pixels 26 in each same row of the sub-pixels are arranged in a pattern of repeating “RGB” sub-pixel groups. Thus the sub-pixels 26 in each column are capable of displaying the same color. In each row, each group of a green sub-pixel 26, an adjacent red sub-pixel 26, and an adjacent blue sub-pixel 26 cooperatively constitute a pixel (not labeled). The second substrate includes a plurality of common electrodes corresponding to the pixel electrodes 251 respectively. The first gray scale voltages and the second gray scale voltages are applied to a row of sub-pixels 26 simultaneously via corresponding data lines 24.

The driving method of the liquid crystal panel 20 is described as follows. In order to simplify the following explanation, only 4×6 pixels forming a matrix are shown. Other pixels of the liquid crystal display have a polarity arrangement similar to the illustrated matrix. Each of the first and second data driving circuits 221, 222 is schematically connected to 6 successive sub-pixels 26 or two adjacent pixels.

The sub-pixels 26 are driven according to the 2-line inversion driving method horizontally. Moreover, the polarities of the sub-pixels 26 in each row that receive the first gray scale voltages provided by the first data driving circuits 221 are correspondingly in a reverse order to the polarities of the sub-pixels 26 in the same row that receive the second gray scale voltages provided by the second data driving circuit 222.

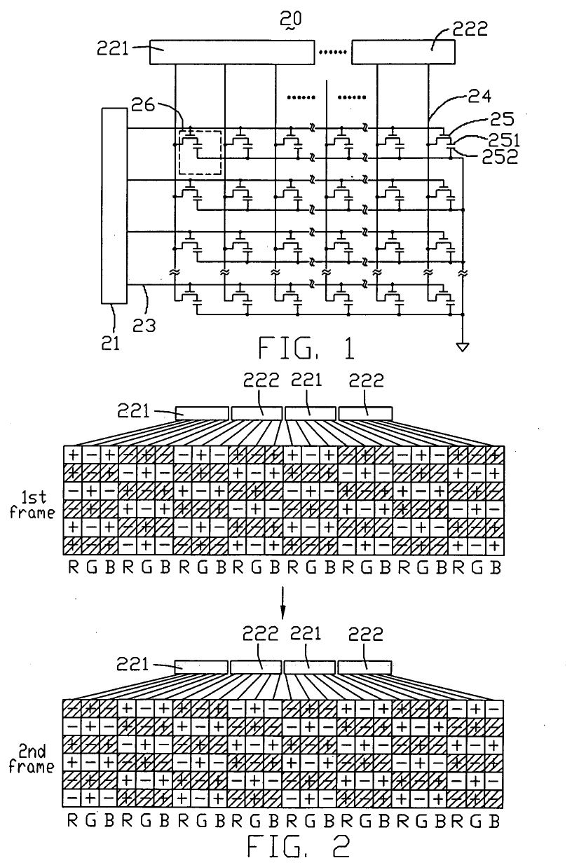

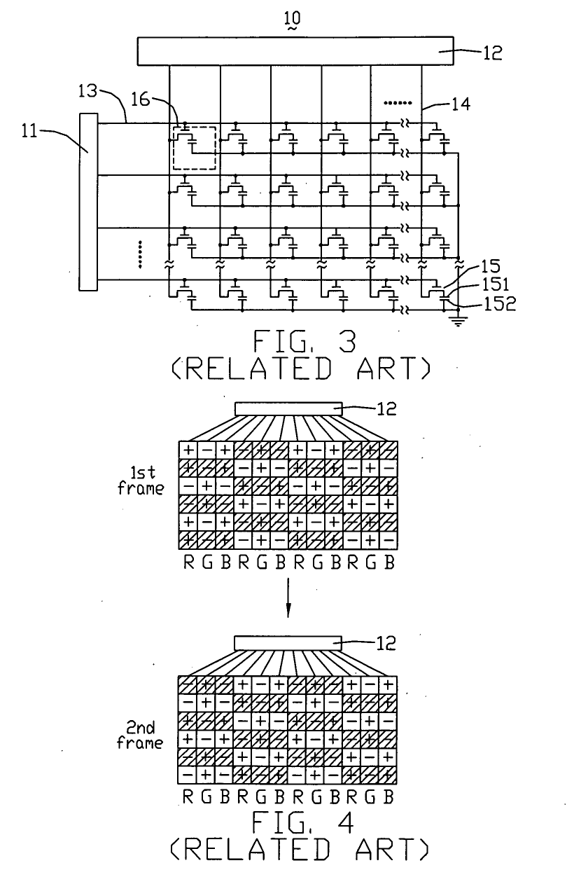

As shown in FIG. 2, taking the first row as an example, the sub-pixels 26 receiving the first gray scale voltages provided by the first data driving circuit 221 have the polarities as “+ − + − + −” from left to right, and the sub-pixels 26 receiving the second gray scale voltages provided by the second data driving circuit 222 have the polarities as “− + − + − +” from left to right. That is, the first gray scale voltages provided by the first data driving circuits 221 are correspondingly different to the second gray scale voltages provided by the second data driving circuits 222 in view of comparing to a predetermined ideal common voltage, namely, an ideal common voltage.

The pixels that have light rays passing there through are defined as bright pixels, and the pixels that have no light rays passing there through are defined as black pixels. For each row and each column of the sub-pixels 26, the bright pixels and the black pixels are arranged alternately horizontally and vertically.

An amount of the sub-pixels 26 in each row having positive polarities of the bright pixels is equal to an amount of the sub-pixels 26 with negative polarities of the bright pixels in the same row. The common electrodes 252 having voltages jumping variation are equal to the common electrodes 252 having voltages dropping variation in quantity, that is the variations canceling out each other. Thus, an actual common voltage of each row of sub-pixels 26 is essentially equivalent to the ideal common voltage when the image display from one frame to next second frame. Such that a color shift phenomenon can be decreased or even eliminated because the actual common voltage of each row of the sub-pixels 26 substantially remains stable.

The liquid crystal panel 20 can preferably include five first data driving circuits 221 and five second data driving circuits 222 arranged alternately, and each of the first and second data driving circuits 221, 222 corresponds to 432 data lines 24. Therefore, the liquid crystal panel 20 has 1440 (10×432/3=1440) pixels and is adapted to a horizontal resolution of a normal 19-inch wide liquid crystal panel.

In summary, the liquid crystal panel 20 includes the first and second data driving circuits 221, 222. The sub-pixels 26 in each row that receive the first gray scale voltages having polarities correspondingly opposite to the sub-pixels in the same row that receive the second gray scale voltages such that the sub-pixels 26 in each row have a same amount of bright pixels having positive polarities and negative polarities.

In fact, the amount of the first and second data driving circuits 221, 222 can be at least one, or any suitable numbers associated with any other embodiment of the invention.

It is to be further understood that even though numerous characteristics and advantages of preferred and exemplary embodiments have been set out in the foregoing description, together with details of the structures and functions of the embodiments, the disclosure is illustrative only; and that changes may be made in detail within the principles of the present invention to the full extent indicated by the broad general meaning of the terms in which the appended claims are expressed.

What is claimed is:

1. A liquid crystal panel comprising:
a plurality of scanning lines that are parallel to each other;
a plurality of data lines that are parallel to each other and orthogonal to the scanning lines;
at least one first data driving circuit configured for providing a plurality of gray scale voltages to part of immediately adjacent data lines; and
at least one second data driving circuit configured for providing a plurality of gray scale voltages to the other part of the data lines;
wherein the scanning lines and date lines cooperatively define a plurality of sub-pixels formed in a matrix, the polarities of the sub-pixels in each row that receive the first gray scale voltages being correspondingly opposite to the polarities of the sub-pixels in the same row that receive the second gray scale voltages.

2. The liquid crystal panel in claim 1, further comprising a gate driving circuit configured for providing a plurality of scanning signals to the scanning lines.

3. The liquid crystal panel in claim 1, wherein polarities of the sub-pixels in each row being same to an adjacent row and opposite to the other adjacent row, polarities of each sub-pixels being reversed once a frame.

4. The liquid crystal panel in claim 3, wherein the first gray scale voltages and the second gray scale voltages are applied to a row of sub-pixels simultaneously.

5. The liquid crystal panel in claim 3, wherein each row of the sub-pixels that receive the first gray scale voltages have polarities as “+ − + − + − . . . ”, and each row of the sub-pixels that receive the second gray scale voltages have the polarities as “− + − + − + . . . ”.

6. The liquid crystal panel in claim 3, wherein each of the sub-pixels in a same row that receive the first gray scale voltages has a polarity different from polarities of adjacent sub-pixels in the same row.

7. The liquid crystal panel in claim 3, wherein each of the sub-pixels in a same row that receive the second gray scale voltages has a polarity different from polarities of adjacent sub-pixels in the same row.

8. The liquid crystal panel in claim 3, wherein the sub-pixels comprises a plurality of red sub-pixels, a plurality of green sub-pixels, and a plurality of blue sub-pixels arranged in a regular, repeating array, each three horizontal adjacent sub-pixels having one red sub-pixel, one green sub-pixel, and one blue sub-pixel, each column of sub-pixels being red sub-pixels, green sub-pixels, or blue sub-pixels.

9. The liquid crystal panel in claim 1, further comprising a plurality of thin film transistors arranged in a matrix at vicinity of points of intersection of the data lines and the data lines.

10. The liquid crystal panel in claim 9, further comprising a plurality of pixel electrodes corresponding to the thin film transistors and a plurality of common electrodes corresponding to the pixel electrodes.

11. The liquid crystal panel in claim 1, wherein the common electrodes have a predetermined common voltage applied thereof.

12. A method for driving a liquid crystal panel, the liquid crystal panel comprising a plurality of sub-pixels, the method comprising:
providing a plurality of first gray scale voltages and a plurality of second gray scale voltages to each row of the sub-pixels, the first gray scale voltages being configured for providing different polarities to corresponding sub-pixels;
providing a predetermined inversion driving pattern for each row of the sub-pixels, each sub-pixels having a positive polarity or a negative polarity, the sub-pixels in each row that receive the first gray scale voltages having different polarity from polarity of adjacent sub-pixels, the sub-pixels in each row that receive the second gray scale voltages having different polarity from polarity of adjacent sub-pixels, the polarities of the sub-pixels in each row that receive the first gray scale voltages being correspondingly opposite to the polarities of the sub-pixels in the same row that receive the second gray scale voltages;
providing a predetermined inversion driving pattern for each sub-pixels, wherein each sub-pixel of an odd row of sub-pixels has a polarity same to a polarity of a sub-pixel of next even row of sub-pixels, and polarities of the sub-pixels are reversed once in a frame period.

13. The method in claim 12, wherein the first gray scale voltages and the second gray scale voltages are applied to the sub-pixels in the same row simultaneously.

14. The method in claim 12, wherein the first gray scale voltages are provided by a plurality of first data driving circuits, and the second gray scale voltages are provided by a plurality of second data driving circuits.

15. The method in claim 14, wherein an amount of the first data driving circuits is equal to an amount of the second data driving circuits.

16. The method in claim 15, wherein each of the first and second data driving circuits corresponds to the same amount of sub-pixels.

17. The method in claim 12, wherein the red, green, and blue sub-pixels are arranged in a patter of repeating “RGB” in each row of the sub-pixels.

18. The method in claim 12, wherein each row of the sub-pixels that receive the first gray scale voltages have polarities as “+ − + − + − . . . ”, and each row of the sub-pixels that receive the second gray scale voltages have the polarities as “− + − + − + . . . ”.
